(19) United States
(12) Patent Application Publication
(10) Pub. No.: US 2019/0350813 A1
(43) Pub. Date: Nov. 21, 2019

(54) TABLET SPLITTING APPARATUS

(71) Applicant: TOSHO INC., Tokyo (JP)

(72) Inventor: Yoshihito Omura, Tokyo (JP)

(21) Appl. No.: 16/476,159

(22) PCT Filed: Jan. 5, 2018
(86) PCT No.: PCT/JP2018/000070

§ 371 Date: Jul. 5, 2019

(30) Foreign Application Priority Data
Jan. 6, 2017 (JP) 2017-000851

(51) Int. Cl. A61J 7/00; B26D 1/06; B26D 3/30

(52) U.S. Cl. CPC A61J 7/0007; B26D 3/30; B26D 1/06

(57) ABSTRACT

A rotation transmission shaft that extends vertically to penetrate a box body is provided. When the box body is placed on a base portion of a tablet feeder mounted in a medicine dispensing apparatus, a lower end portion of the rotation transmission shaft is coupled to the base portion so as to be able to transmit rotation, and a tablet guiding mechanism is coupled to a cut tablet piece receiving portion of the base portion. When a tablet cassette configured to discharge tablets housed in a random manner, one at a time, as a rotor rotates is placed on the box body, an upper end portion of the rotation transmission shaft is coupled to the rotor to be able to transmit rotation, and the tablet guiding mechanism is coupled to a tablet discharging portion of the tablet cassette.

### TECHNICAL FIELD

The present invention relates to a tablet splitting apparatus that cuts a tablet into several cut tablet pieces, and particularly to a tablet splitting apparatus that is suitably mountable to a base portion, to which a tablet cassette which is a removable portion of a tablet feeder is mountable, in a medicine dispensing apparatus that includes a large number of tablet feeders configured to store a large number of tablets in a random manner to sequentially discharge the tablets.

### BACKGROUND ART

There are tablet splitting apparatuses according to the related art automated to a certain level or higher (see Patent Documents 1 to 7, for example), besides manual tablet splitting apparatuses. The automated tablet splitting apparatuses according to the related art include a cutting mechanism capable of cutting a tablet into two half tablets etc. and a tablet feeder configured to store a large number of tablets in a random manner to sequentially discharge the tablets, and the tablet feeder and the cutting mechanism operate in conjunction with each other to supply required cut tablet pieces at appropriate times. Some of the tablet splitting apparatuses are used as mounted in a medicine dispensing apparatus (see Patent Documents 1 and 2, for example), and others are used independently of the medicine dispensing apparatus (see Patent Documents 3 to 7, for example). Some cutting mechanisms use an advanceable-retractable blade (see Patent Documents 1 to 3 and 4 to 7, for example), and others use a rotary blade (see Patent Document 3, for example).

When combinations of the cutting mechanism and the tablet feeder are considered, the tablet feeder includes a feeder base (base portion) that includes a driving member such as an electric motor, and a removable tablet cassette that includes a passive member. When combinations of the cutting mechanism and the tablet feeder are considered for cases where tablets are discharged with the tablet cassette placed on the base portion, the feeder base and the cutting mechanism are installed in a body portion of the tablet splitting apparatus of the independent type (see Patent Documents 3 to 7, for example). When the tablet cassette is mounted to the body portion, tablets dropped and discharged from the tablet cassette, one tablet at a time, fall while passing through a falling passage provided in the feeder base, and fall to the cutting mechanism.

For combinations of the cutting mechanism and the tablet feeder in the tablet splitting apparatuses of the type mounted in the medicine dispensing apparatus (see Patent Documents 1 and 2, for example), in contrast, the base portion of the tablet feeder mounted in a normal manner in the medicine dispensing apparatus is also used for the tablet cassette and the feeder base. The cutting mechanism is provided as a separate unit, mounted in the medicine dispensing apparatus as stored directly under a tablet feeder storage or in a vacant space formed in the tablet feeder storage after taking out a different tablet feeder, and connected to corresponding one of upstream tablet feeders through a tablet guiding conduit. Also in the tablet splitting apparatuses of this type, tablets dropped and discharged from the tablet cassette, one tablet at a time, fall while passing through the base portion of the feeder, and fall to the cutting mechanism.

### RELATED-ART DOCUMENT

### Patent Document

Patent Document 1: JP 11-226088 A
Patent Document 2: JP 11-226089 A
Patent Document 3: JP 2011-83357 A
Patent Document 4: JP 2011-97969 A
Patent Document 5: JP 2012-29800 A
Patent Document 6: JP 2012-179127 A
Patent Document 7: JP 2013-039236 A

### SUMMARY OF INVENTION

### Technical Problem

In the tablet splitting apparatuses of the type mounted in the medicine dispensing apparatus according to the related art, a unit for installation in which the driving member is provided to the cutting mechanism has a horizontally long shape, and therefore can be conveniently installed directly under the tablet feeder storage or the like. If the tablet splitting apparatus is installed in the tablet feeder storage, however, one unit for installation occupies a space for placement of two adjacent tablet cassettes. Therefore, three cassette placement spaces for the unit for installation and the tablet cassette which supplies tablets to be split are used to mount one tablet splitting apparatus. If the number of tablet splitting apparatuses mounted in the storage is increased, the number of tablet cassettes mounted for normal use, and hence the number of kinds of tablets that can be automatically dispensed, may be drastically decreased.

An object of the present invention is to provide a tablet splitting apparatus that can be compactly mounted at a location for mounting of a tablet cassette in a medicine dispensing apparatus.

### Solution to Problem

The tablet splitting apparatus according to the present invention has been devised to address the foregoing issue. The tablet splitting apparatus according to the present invention includes: a tablet guiding mechanism configured to receive a fallen tablet and guide the tablet to a cutting position; a cutting mechanism capable of cutting the tablet at the cutting position; a driving mechanism provided at a side of the cutting mechanism to drive the cutting mechanism; and a box body that houses the tablet guiding mechanism and the cutting mechanism. The tablet splitting apparatus according to the present invention is housed in a tablet dispensing apparatus including a plurality of tablet cassettes and configured to cut the tablet falling from corresponding one out of the plurality of tablet cassettes. The tablet cassettes each contain a plurality of tablets in a random manner, and are each configured to discharge the plurality of tablets, one at a time, to allow the tablet to fall from a tablet discharging portion of the tablet cassette as a rotor rotates to align the plurality of tablets.

The box body includes a rotation transmission shaft that extends vertically and a rotation transmission mechanism that causes a movable portion of the tablet guiding mechanism to operate as the rotation transmission shaft rotates. The box body has a lower portion placed on a base portion of a tablet feeder for the tablet cassette, and an upper portion on which the tablet cassette is placed. The upper portion has a through hole formed therein, from which an upper end portion of the rotation transmission shaft is exposed, and includes a tablet receiving portion that receives the tablet discharged from the tablet discharging portion. A lower end portion of the rotation transmission shaft is exposed from the lower portion of the box body, and the lower portion of the box body includes a cut tablet piece delivering portion configured to deliver a plurality of cut tablet pieces formed by cutting the tablet using the cutting mechanism.

The lower end portion of the rotation transmission shaft is coupled to a driving shaft of the base portion so as to be able to transmit rotation, and the cut tablet piece delivering hole of the tablet guiding mechanism is coupled to a tablet receiving portion of the base portion, by placing the box body on the base portion of the tablet feeder. The upper end portion of the rotation transmission shaft is coupled to the rotor in the tablet cassette so as to be able to transmit rotation, and the tablet receiving hole of the tablet guiding mechanism is coupled to the tablet discharging portion of the tablet cassette, by placing the tablet cassette on the box body.

In the tablet splitting apparatus according to the present invention, the box body which stores the cutting mechanism etc. can be interposed between the tablet cassette and the base portion of the tablet feeder. Thus, not only the tablet cassette but also the cutting mechanism etc. can be compactly mounted at a location for mounting of the tablet cassette in the medicine dispensing apparatus if the tablet cassette which is short in height is adopted. Moreover, the tablet is cut below the tablet cassette. Thus, powder dust, fragments, etc. generated by cutting do not adhere to the inner surface of the tablet cassette or clog a tablet alignment portion. Thus, a reduction in the performance that may be caused depending on the manner of implementation of a cutter blade can be avoided.

When the rotation transmission shaft which extends vertically in the box body is introduced and the box body is interposed between the tablet cassette and the base portion, rotation is accordingly transmitted from the base portion to the tablet cassette. Thus, the tablet splitting apparatus can be conveniently installed in the tablet feeder storage, whether the medicine dispensing apparatus is newly installed or was previously installed. Moreover, the ease of mounting/unmounting etc. of the tablet cassette is not impaired but maintained, which provides high practicality. Further, the cutting mechanism is driven by the driving mechanism, and thus no excessive load is applied to the base portion.

Thus, the present invention can achieve a tablet splitting apparatus with high practicality etc. that can be compactly mounted at a location for mounting of a tablet cassette in a medicine dispensing apparatus.

In the tablet splitting apparatus according to the present invention, the tablet guiding mechanism may include, as the movable portion, a disk-shaped rotating body, in a peripheral portion of which a plurality of recesses are formed. The disk-shaped rotating body may be coupled to the rotation transmission shaft via the rotation transmission mechanism so as to be able to transmit rotation, and may be rotated to move the tablets which are received and held in the recesses. With such a configuration, the tablets are transported as received in the recesses formed in the peripheral portion of the disk-shaped rotating body. Thus, the tablets can be simply and adequately moved and delivered through rotational motion of the disk-shaped rotating body, and the tablets can be accurately set in a stable state at the cutting position without applying an impact to the tablets. Moreover, the disk-shaped rotating body is coupled to the rotation transmission shaft via the rotation transmission mechanism. Thus, dedicated rotation driving means is not required, and the base portion does not need to be reinforced since the load of rotating the disk-shaped rotating body is light.

Preferably, a virtual center line that passes through a center of rotation of the disk-shaped rotating body extends in a direction orthogonal to an axis of the rotation transmission shaft, and the rotation transmission mechanism which is located between the rotation transmission shaft and the disk-shaped rotating body is a bevel gear mechanism. The base portion does not need to be reinforced since the bevel gear mechanism is simple in structure and light in weight.

A ratio of rotation transmission from the rotation transmission shaft to the rotor of the tablet cassette and a ratio of rotation transmission from the rotation transmission shaft to the disk-shaped rotating body may be correlated to synchronize tablet discharge from the tablet cassette and tablet reception into the recesses of the disk-shaped rotating body. With such a configuration, the timing when the tablet cassette discharges the tablets and the timing when the recesses of the disk-shaped rotating body receive the tablets are synchronized with each other. Thus, the tablets can be smoothly delivered from the tablet cassette to the tablet guiding mechanism. Moreover, such synchronization can be conveniently achieved by correlating the rotation transmission ratio from the rotation transmission shaft to the rotor and the rotation transmission ratio from the rotation transmission shaft to the disk-shaped rotating body.

The tablet guiding mechanism preferably includes a rotating body housing portion configured to rotatably receive the disk-shaped rotating body, and an open/close plate. The open/close plate is disposed under the disk-shaped rotating body to be brought into a closed state to prevent the tablet from falling from the recess when the tablet comes to the cutting position, and brought into an open state to enable the plurality of cut tablet pieces to fall into the cut tablet piece delivering portion when the tablet is cut. Providing the rotating body housing portion and the open/close plate can prevent the tablet from falling from the disk-shaped rotating body, and allows the cut tablet pieces to be reliably delivered from the cut tablet piece delivering portion to the base portion.

The cutting mechanism may include a movable blade driven by the driving mechanism and a fixed blade provided to face the movable blade, and the tablet, which is held in the recess of the disk-shaped rotating body and located at the cutting position, may be interposed between the movable and fixed blades. In this case, the driving mechanism may include a driving rotary shaft having an axis line extending in parallel with a virtual line extending in a direction orthogonal to an axial direction of the rotation transmission shaft and located opposite to the fixed blade with the rotation transmission shaft interposed therebetween, a cam fixed to the driving rotary shaft, and a follower moved by the cam. The cam and the follower may be configured to move the movable blade, which is located opposite to the driving rotary shaft with the rotation transmission shaft interposed therebetween, so as to approach and depart from the fixed blade. When this structure is adopted, components that constitute the cutting mechanism can be disposed on both sides of the rotation transmission shaft, which reduces the area occupied by the cutting mechanism in the box body.

The open/close plate may be configured to be driven by the driving mechanism in synchronization with movement of the movable blade. With such a configuration, the driving mechanism can be utilized as the driving source for the open/close plate.

Respective heights of the box body and the tablet cassette may be determined such that a height of an assembly constituted by placing the tablet cassette on the box body is equal to or less than a height of a standard tablet cassette (a tablet cassette not to be combined with the tablet splitting apparatus) placed on the base portion of the tablet splitting apparatus. With such a configuration, a tablet splitting apparatus that can be used for the existing tablet dispensing apparatus can be provided.

### BRIEF DESCRIPTION OF DRAWINGS

FIG. 1 illustrates the structure of a tablet splitting apparatus according to a first embodiment of the present invention, in which FIG. 1A is a front view of a tablet cassette, a tablet splitting apparatus, and a base portion in a separated state, FIG. 1B is a front view of the tablet cassette, the tablet splitting apparatus, and the base portion in a mounted state, and FIG. 1C is a plan view of the tablet cassette with a top plate portion of a box body cut away.

FIG. 2A is a sectional view of the tablet splitting apparatus taken along line A-A, and FIG. 2B is a sectional view of the tablet splitting apparatus taken along line B-B.

FIG. 3 is a schematic view of a medicine dispensing apparatus in which a plurality of tablet splitting apparatuses are mounted in a tablet feeder storage.

FIG. 4 is an exploded perspective view illustrating the actual tablet cassette.

FIG. 5 is a sectional view of an example of a specific configuration of a cutting mechanism, a tablet guiding mechanism including a disk-shaped rotating body, a rotation transmission mechanism, and a rotation/reciprocation conversion portion.

FIG. 6 is an exploded perspective view of a specific embodiment of the main portion of the cutting mechanism and a driving mechanism.

FIGS. 7A and 7B illustrate operation of the cutting mechanism illustrated in FIG. 6.

### DESCRIPTION OF EMBODIMENTS

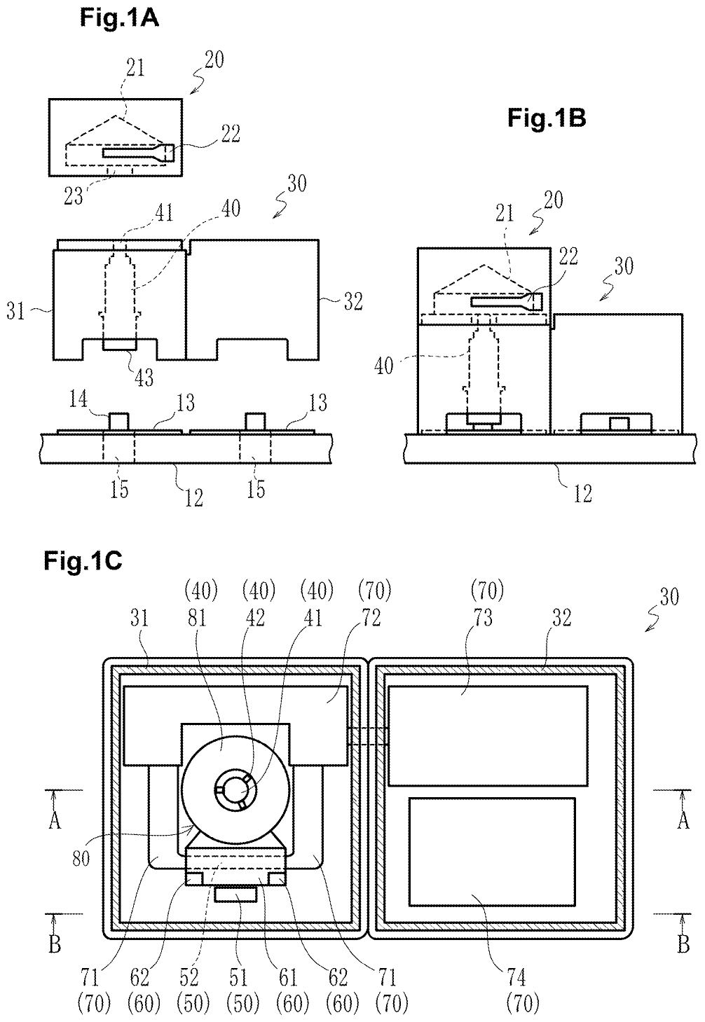

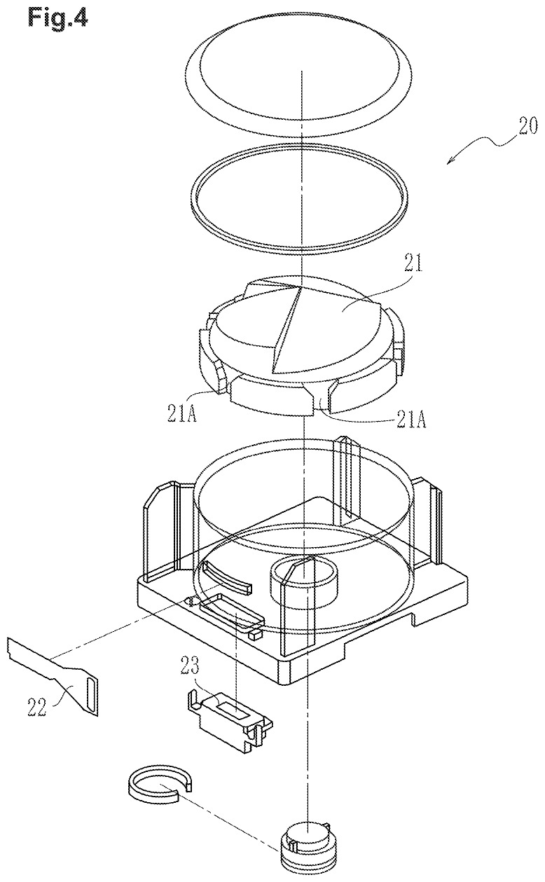

A tablet splitting apparatus according to an embodiment of the present invention will be described in detail. FIGS. 1 to 3 illustrate a schematic configuration of the present embodiment. FIGS. 4 to 7 illustrate a detailed structure of some members used in the embodiment in FIGS. 1 to 3.

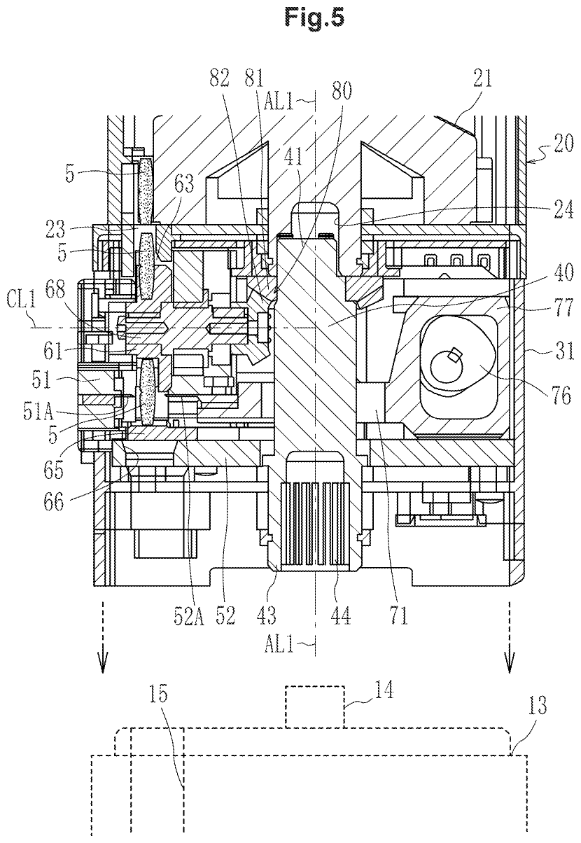

In FIGS. 1 to 3, for the sake of clarity etc., fasteners such as bolts, couplers such as hinges, power transmission members such as gears and timing belts, electric circuits such as motor drivers, and electronic circuits such as controllers are not illustrated, and components necessary for or related to the description of the present invention are mainly illustrated. In FIGS. 4 to 7, the same components as those used to describe the embodiment illustrated in FIGS. 1 to 3 are denoted by the same reference numerals as the reference numerals affixed to their counterparts in FIGS. 1 to 3. In FIG. 5 etc., sectional surfaces of main components necessary for the description are hatched.

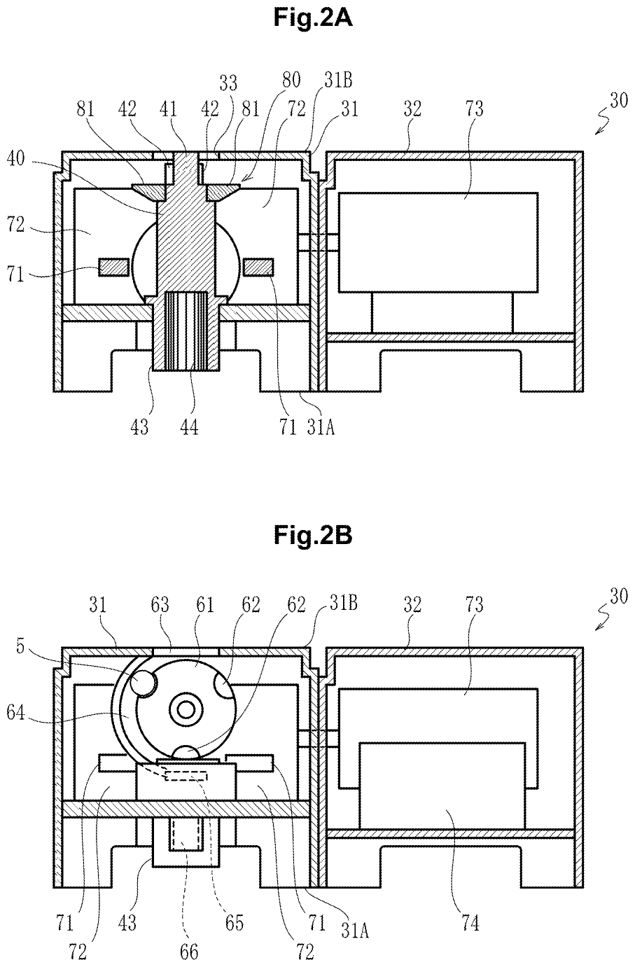

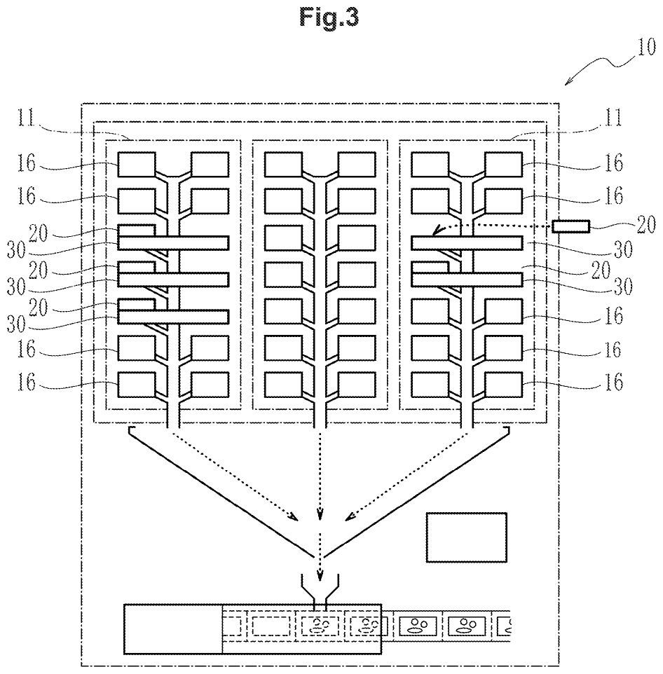

FIG. 1A is a front view of a tablet cassette 20, a tablet splitting apparatus 30, and a base portion 13 in a separated state. FIG. 1B is a front view of the tablet cassette 20, the tablet splitting apparatus 30, and the base portion 13 in amounted state. FIG. 1C is a plan view of the tablet splitting apparatus 30 in which respective upper wall portions of two box bodies 31 and 32 are cut away. FIG. 2A is a sectional view of the tablet splitting apparatus 30 taken along line A-A in FIG. 1C. FIG. 2B is a sectional view of the tablet splitting apparatus 30 taken along line B-B in FIG. 1C. FIG. 3 is a schematic view of a medicine dispensing apparatus 10 in which a large number of standard tablet cassettes 16 and a plurality of tablet splitting apparatuses 30 are mounted in a tablet feeder storage 11.

First of all, the tablet cassette 20 which is used as placed on the box body 31 for an actuation portion of the tablet splitting apparatus 30 is described with reference to FIGS. 1A, 1B, and 4. FIG. 4 is an exploded perspective view illustrating the actual tablet cassette 20. The tablet cassette 20 basically has a structure similar to that of a large number of normal standard tablet cassettes 16 mounted in the tablet feeder storage 11 of the medicine dispensing apparatus 10. However, the lower end portion of a rotor 21 and a tablet discharging portion 23 are deformed to be adapted to the upper structure of the box body 31 for an actuation portion, rather than to the base portion 13. The tablet cassette 20 is shorter in height than the standard tablet cassette 16, and is accordingly configured to store a smaller number of tablets above a partition plate 22. Since the number of cut tablet pieces formed by cutting the tablets is twice or more the number of the original tablets and, in general, the cut tablet pieces formed by cutting the tablets are not frequently dispensed, however, the advantage of the increased number of tablet splitting apparatuses mounted is much more significant than the disadvantage of the decreased amount of tablets stored. The function of the rotor 21 and the partition plate 22 to place and align tablets 5 in slits 21A formed at predetermined intervals along the outer periphery of the rotor 21 is described in detail in JP 2015-12893 A with reference to FIGS. 8 and 9, and thus is not described in detail herein.

An overall configuration of the tablet splitting apparatus 30 (see FIGS. 1A and 1B) based on the purpose of use thereof will be described first. The tablet splitting apparatus 30 according to the present embodiment is to be mounted in the medicine dispensing apparatus 10 by replacing the normal standard tablet cassette 16 illustrated in FIG. 3. The tablet splitting apparatus 30 is removably mountable on two adjacent base portions 13 and 13 (FIGS. 1A and 1B) provided on a shelf 12 of the tablet feeder storage 11 of the medicine dispensing apparatus 10, and used as mounted thereon. The tablet splitting apparatus 30 allows the dedicated tablet cassette 20 to be removably mounted thereon. The tablet splitting apparatus 30 receives, from a tablet receiving portion 63 [FIG. 2B], tablets dropped from the tablet discharging portion 23 of the tablet cassette 20 which is mounted thereon, cuts each of the tablets into two half tablets (a plurality of cut tablet pieces) using a cutting mechanism 50 [FIG. 1C], and thereafter drops the half tablets into a cut tablet piece receiving portion 15 [FIG. 1A] of the base portion 13, one half tablet at a time. In the present embodiment, further, the total height of an assembly in which the tablet cassette 20 is placed on the tablet splitting apparatus 30 generally coincides with (or is equal to or less than) the height of the normal tablet cassette (standard tablet cassette) 16.

The configuration of single components will be discussed next (see FIGS. 1, 2, and 4 to 7). The tablet splitting apparatus 30 includes: a tablet guiding mechanism 60 configured to receive the tablets 5 dropped from the tablet discharging portion 23 of the tablet cassette 20 in the tablet receiving portion 63 and guide the tablets 5 onto an open/close plate 65 [FIGS. 2B and 5] located under a cutting position for the tablet 5; the cutting mechanism 50 capable of cutting the tablet 5 at the cutting position; a driving mechanism 70 provided at a side of the cutting mechanism 50 to drive operation of the cutting mechanism 50; the box body 31 for an actuation portion which stores the cutting mechanism 50, the tablet guiding mechanism 60, and power transmission portions for the driving mechanism 70; the box body 32 for a motor which stores a driving source etc., of the driving mechanism 70, that cannot be housed in the box body 31 for an actuation portion; a rotation transmission shaft 40 that extends vertically to penetrate the box body 31 for an actuation portion; and a rotation transmission mechanism 80 that causes a movable portion of the tablet guiding mechanism 60 to operate as the rotation transmission shaft 40 rotates.

The various portions will be discussed in detail below. The box body 31 for an actuation portion and the box body 32 for a motor may be integrated with each other. In this example, the box bodies 31 and 32 are made separately from each other in consideration of ease of manufacture, maintenance, etc. The box bodies 31 and 32 can be handled integrally after placing internal components in the box bodies 31 and 32 and coupling the adjacent box bodies 31 and 32 to each other, or after coupling the adjacent box bodies 31 and 32 to each other and placing internal components in the box bodies 31 and 32. The height of the box body 31 for an actuation portion is about half or more that of the normal tablet cassette 16. The height of the box body 32 for a motor is slightly more than that of the box body 31 for an actuation portion.

The box body 31 has a lower portion 31A placed on the base portion 13 of the tablet feeder for the standard tablet cassette 16, and an upper portion 31B on which the tablet cassette 20 is placed. The upper portion 31B has a through hole 33 formed therein, from which an upper end portion 41 of the rotation transmission shaft 40 is exposed, and includes the tablet receiving portion 63 [FIGS. 2B and 5] that receives the tablet 5 discharged from the tablet discharging portion 23 [FIGS. 1A and 5]. A lower end portion 43 of the rotation transmission shaft 40 is exposed from the lower portion 31A of the box body 31, and the lower portion 31A includes a cut tablet piece delivering portion 66 [FIGS. 2B and 5] configured to deliver a plurality of cut tablet pieces formed by cutting the tablet 5 using the cutting mechanism 50.

As illustrated in FIGS. 1A, 1B, and 5, when the box bodies 31 and 32 are placed on the base portion 13 of the tablet feeder, the lower end portion 43 of the rotation transmission shaft 40 is coupled to a spline shaft (driving shaft) 14 of the base portion 13 so as to be able to transmit rotation, and the cut tablet piece delivering portion 66 of the tablet guiding mechanism 60 is coupled to the cut tablet piece receiving portion 15 of the base portion 13. When the tablet cassette 20 is placed on the box body 31, the upper end portion 41 of the rotation transmission shaft 40 is coupled to the rotor 21 in the tablet cassette 20 so as to be able to transmit rotation, and the tablet receiving portion 63 of the tablet guiding mechanism 60 is coupled to the tablet discharging portion 23 of the tablet cassette 20.

The rotation transmission shaft 40 has a shaft body rotatably supported upright close to the center position inside the box body 31 for an actuation portion (see FIGS. 1A and 5), and a meshing wall 44 is formed on the inner peripheral surface of a hole opening in an end surface of the lower end portion 43 (see FIG. 2A). The lower end portion 43 of the rotation transmission shaft 40, including the meshing wall 44, is similar to the lower end portion of the rotor of the standard tablet cassette 16. Therefore, when the box body 31 for an actuation portion is placed on the base portion 13 of the tablet feeder to be mounted in the medicine dispensing apparatus (see FIGS. 1A and 1B), the spline shaft (driving shaft) 14 of the base portion 13 for driving the tablet cassette is fitted into the hole at the lower end portion 43 of the rotation transmission shaft 40 so that the meshing wall 44 at the lower end portion 43 and the spline shaft 14 are meshed with each other. As a result, the lower end portion 43 of the rotation transmission shaft 40 is coupled to the base portion 13 so as to be able to transmit rotation.

A plurality of (three in the illustrated example) meshing blades 42 are formed at the upper end portion 41 of the rotation transmission shaft 40 (see FIGS. 1C and 2A) to project radially in outer radial directions from the shaft portion. The upper end portion 41, including the shaft portion and the meshing blades 42, is fitted with a fitting hole 24 at the lower end portion of the rotor 21 of the tablet cassette 20 in the male-female relationship. Therefore, the rotation transmission shaft 40 is configured such that the upper end portion 41 of the rotation transmission shaft 40 and the rotor 21, and hence the rotation transmission shaft 40 and the rotor 21, are coupled to each other so as to be able to transmit rotation when the tablet cassette 20 is placed on the box body 31 for an actuation portion (see FIG. 1B).

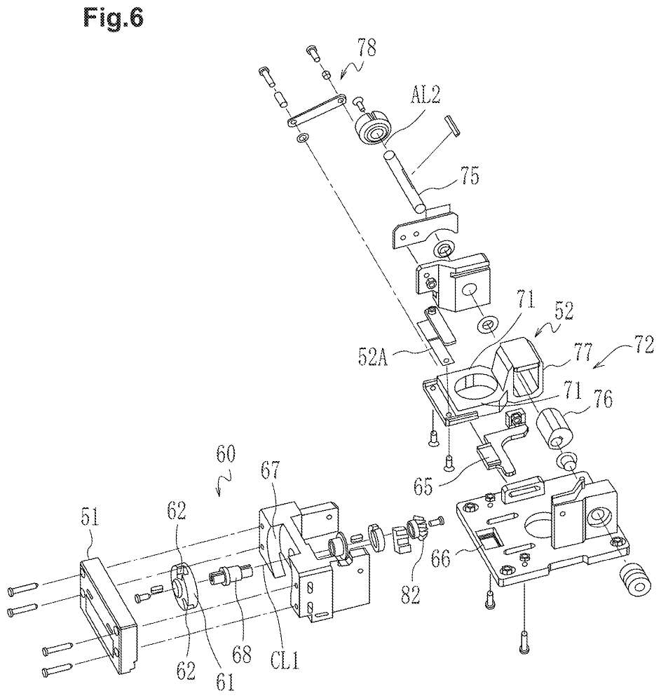

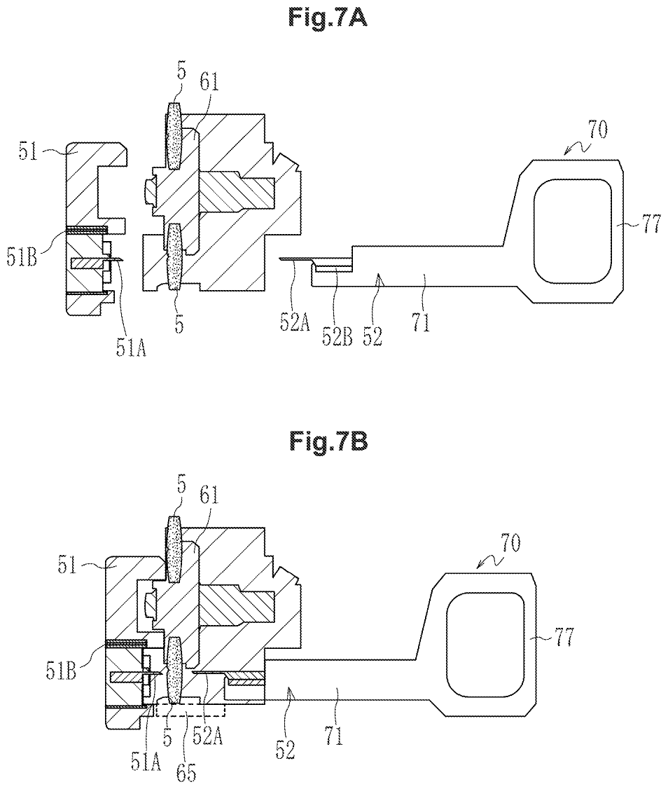

FIG. 6 is an exploded perspective view of a specific embodiment of the main portion of the cutting mechanism 50 and the driving mechanism 70. FIGS. 7A and 7B illustrate operation of the cutting mechanism 50 illustrated in FIG. 6. The cutting mechanism 50 and the driving mechanism 70 will be described below with reference to FIGS. 6, 7A, 7B, 1A to 1C, 2A, and 2B. The cutting mechanism 50 (see FIGS. 1C, 6, 7A, and 7B) adopts a known opposed blade system (see Patent Documents 1 and 2), and includes a fixed blade unit 51 having a fixed blade 51A and a movable blade unit 52 having a movable blade 52A. In this example, since the cutting position for the tablet 5 is on the open/close plate 65 (see FIG. 2B) as discussed above, the fixed blade unit 51 is fixed immediately before the cutting position (see FIG. 1C), and the movable blade unit 52 is held at a location slightly behind the cutting position for the tablet 5 and before the rotation transmission shaft 40 so as to be advanceable and retractable (see FIG. 1C). When the movable blade unit 52 is advanced toward the fixed blade unit 51, the tablet 5 at the cutting position (on the open/close plate 65) is vertically cut into two half tablets (cut tablet pieces). The position, in the height direction, of the blades 51A and 52A of the units 51 and 52 can be conveniently aligned with the tablet 5 by changing shims 51B and 52B for clamping [FIG. 7A].

The driving mechanism 70 (see FIGS. 1C, 2, 5, and 6) advances and retracts the movable blade unit 52 to cut the tablet. To that end, the driving mechanism 70 includes: a pair of advancing/retracting portions 71 and 71 configured to hold the movable blade unit 52 having the movable blade 52A at the front end portion thereof; a motor 73 [FIG. 1C] operable to rotate an output shaft; a rotation/reciprocation conversion portion 72 configured to convert rotational motion of the motor 73 into linear motion and transmit the linear motion to the advancing/retracting portions 71 and 71; and a driver 74 configured to supply driving power to the motor 73. In the driving mechanism 70 (see FIG. 1C), in order to avoid interference between such components and the rotation transmission shaft 40, the advancing/retracting portions 71 and 71 are provided as two members disposed on both sides of the rotation transmission shaft 40, and the rotation/reciprocation conversion portion 72 is installed in rear of the rotation transmission shaft 40.

The rotation/reciprocation conversion portion 72 can be implemented by a combination of a crank and a slider, a combination of a rotary wheel, a link member, and a slider, etc., for example. The open/close plate 65 is driven to be opened and closed when the movable blade unit 52 is driven to be advanced and retracted in synchronization with motion of the advancing/retracting portions 71.

FIG. 5 is a sectional view of an example of a specific configuration of components of the cutting mechanism 50, the tablet guiding mechanism 60 including a disk-shaped rotating body 61, the rotation transmission mechanism 80, and the rotation/reciprocation conversion portion 72. FIG. 6 is an exploded perspective view of some of the components in FIG. 5.

In the present embodiment, the tablet guiding mechanism 60 (see FIG. 2B) includes: tablet falling paths 63 to 66 that extend from the tablet receiving portion 63 to the cut tablet piece delivering portion 66 by way of a tablet passage 64, the tablet cutting position, and the open/close plate 65; and the disk-shaped rotating body 61 provided directly under the tablet receiving portion 63 to face the tablet passage 64. Among these, the tablet receiving portion 63 is an opening formed in the upper portion 31B of the box body 31 to communicate with the tablet discharging portion 23 [FIGS. 1A and 5] of the tablet cassette 20 which is mounted on the box body 31 for an actuation portion. The tablet passage 64 [FIG. 2B] is formed along the peripheral portion of the disk-shaped rotating body 61 for about half the circumference.

The disk-shaped rotating body 61 (see FIGS. 1C, 2B, and 6) has a disk-shaped portion placed vertically, in which a plurality of (three in the drawings) recesses 62 are formed at equal intervals in the peripheral portion thereof. A bevel gear 82 (see FIGS. 5 and 6) is provided on a rotary shaft 68 of the disk-shaped rotating body 61. The bevel gear 82 is meshed with a bevel gear 81 provided on the rotation transmission shaft 40 (see FIG. 5). This meshing enables the disk-shaped rotating body 61 and the rotation transmission shaft 40 to be coupled to each other so as to be able to transmit rotation. Thus, when the rotation transmission shaft 40 is axially rotated, the disk-shaped rotating body 61 is rotated (rotated on its own axis) in an accompanying manner. In this specific example, a virtual center line CL1 that passes through the center of rotation of the disk-shaped rotating body 61 extends in a direction orthogonal to an axis line AL1 of the rotation transmission shaft 40, and the rotation transmission mechanism 80 which is located between the rotation transmission shaft 40 and the disk-shaped rotating body 61 is a bevel gear mechanism that includes a combination of the two bevel gears 81 and 82.

The recesses 62 (see FIG. 2B) of the disk-shaped rotating body 61 are each formed to be able to receive the tablet 5 with slight play required for the tablet 5 to enter and exit from the recess 62. The recess 62 is configured to receive the tablet 5 from the tablet receiving portion 63 when the recess 62 is directed upward directly at a location under the tablet receiving portion 63, to hold the tablet 5 in the tablet passage 64 when the recess 62 is directed obliquely or laterally to face the tablet passage 64, and to hold the tablet 5 at the tablet cutting position on the open/close plate 65 when the recess 62 is directed downward at a location over the open/close plate 65. The disk-shaped rotating body 61 is rotated while holding the tablets 5 received from the tablet receiving portion 63, one tablet 5 in each recess 62, to move the tablets 5 to the tablet cutting position.

Further, the rotation transmission ratio of rotational motion transmitted from the rotation transmission shaft 40 to the disk-shaped rotating body 61 via the bevel gear 82 and the rotation transmission ratio of rotational motion transmitted from the rotation transmission shaft 40 to the rotor 21 of the tablet cassette 20 are appropriately correlated with each other by setting the gear ratios at the locations of meshing or the like. Specifically, these rotation transmission ratios are set such that the rotor 21 is rotated to discharge one tablet and the disk-shaped rotating body 61 is rotated by the interval of the recesses 62 when the rotation transmission shaft 40 is rotated by a predetermined angle. As a result, the timing when the tablet cassette 20 discharges the tablets downward from the tablet discharging portion 23 and the timing when the recesses 62 of the disk-shaped rotating body 61 receive the tablets via the tablet receiving portion 63 are synchronized with each other in the one-to-one correspondence, and thus an appropriate number, not too many or not too few, of tablets can be delivered from the tablet cassette 20 to the recesses 62.

When the box body 31 for an actuation portion of the tablet splitting apparatus 30 is placed on the base portion 13 (see FIG. 1B), the cut tablet piece delivering portion 66 (see FIGS. 2B and 5) is coupled to the cut tablet piece receiving portion 15 of the base portion 13 in an accompanying manner (see FIG. 1A). This establishes a communicated state in which the half tablets can be delivered to the cut tablet piece delivering portion 66.

When the tablet cassette 20 is placed on the box body 31 for an actuation portion (see FIG. 1B), the tablet receiving portion 63 (see FIGS. 2B and 5) is coupled to the tablet discharging portion 23 of the tablet cassette 20 in an accompanying manner (see FIG. 1A). This establishes a communicated state in which the tablets dropped and discharged from the tablet cassette 20 can be received.

The tablet guiding mechanism 60 illustrated in FIG. 6 has a rotating body housing portion 67 configured to rotatably receive the disk-shaped rotating body 61, and the open/close plate 65. The open/close plate 65 is disposed under the disk-shaped rotating body 61 to be brought into a closed state to prevent the tablet 5 from falling from the recess 62 when the tablet 5 comes to the cutting position, and brought into an open state to enable the plurality of cut tablet pieces to fall into the cut tablet piece delivering portion 66 when the tablet 5 is cut. Providing the rotating body housing portion 67 and the open/close plate 65 can prevent the tablet 5 from falling from the disk-shaped rotating body 61, and allows the cut tablet pieces to be reliably delivered from the cut tablet piece delivering portion to the base portion 13.

The rotation/reciprocation conversion portion 72 of the driving mechanism 70 includes a driving rotary shaft 75 having an axis line AL2 extending in parallel with a virtual line extending in a direction orthogonal to an axial direction of the rotation transmission shaft 40 and located opposite to the fixed blade unit 51 with the rotation transmission shaft 40 interposed therebetween, a cam 76 fixed to the driving rotary shaft 75, and a follower 77 moved by the cam 76. The cam 76 and the follower 77 are configured to move the movable blade unit 52, which is located opposite to the driving rotary shaft 40 with the rotation transmission shaft 75 interposed therebetween, so as to approach and depart from the fixed blade unit 51. In this example, the pair of advancing/retracting portions 71 are integrally provided with the follower 77. A link mechanism 78 is coupled to the driving rotary shaft 75 to drive the open/close plate 65 in synchronization with the movable blade unit 52 as discussed earlier.

When this structure is adopted, components that constitute the cutting mechanism can be disposed on both sides of the rotation transmission shaft, which reduces the area occupied by the cutting mechanism in the box body.

If the motor 73 and the driver 74 which are expensive but super-compact are adopted in FIG. 1C, the motor 73 and the driver 74 can be stored in the box body 31 for an actuation portion together with the rotation/reciprocation conversion portion 72 etc. In this example, however, the motor 73 and the driver 74 which may be stored in the box body 32 for a motor are adopted with a focus placed on the balance between the cost and the advantage.

### (Mode of Use and Operation)

The mode of use and operation of the tablet splitting apparatus 30 according to the present embodiment will be described.

When the tablet splitting apparatus 30 is used as mounted in the tablet feeder storage 11 of the medicine dispensing apparatus 10 (see FIG. 3), two adjacent base portions 13 and 13 in the tablet feeder storage 11 are secured for one tablet splitting apparatus 30, and the tablet splitting apparatus 30 is placed thereon (see FIGS. 3, 1A, and 1B).

Then, the spline shaft 14 of the base portion 13 and the rotation transmission shaft 40 of the tablet splitting apparatus 30 are coupled to each other so as to be able to transmit rotation in an accompanying manner, and thus the rotation transmission shaft 40 and the disk-shaped rotating body 61 which operates in accompaniment therewith become operable according to control by a controller for the medicine dispensing apparatus 10.

When a cable (not illustrated) for power supply or signal transmission for the driver 74 is connected to a power source, the controller, etc. (not illustrated) for the medicine dispensing apparatus 10, the driving mechanism 70 including the motor 73 and the movable blade unit 52 and the open/close plate 65 which are driven thereby become operable according to control by the controller for the medicine dispensing apparatus 10.

In this manner, the tablet splitting apparatus 30 which is mounted to the medicine dispensing apparatus 10 becomes ready for operation, and a location for mounting of two standard tablet cassettes 16 is used as a location for mounting of the tablet cassette 20 via the tablet splitting apparatus 30.

Then, the tablet cassette 20 replenished with tablets is mounted on the box body 31 for an actuation portion of the tablet splitting apparatus 30. Consequently, the tablet discharging portion 23 of the tablet cassette 20 and the tablet receiving portion 63 of the tablet splitting apparatus 30 communicate with each other, and the lower end portion of the rotor 21 and the upper end portion 41 of the rotation transmission shaft 40 are engaged with each other so as to be able to transmit axial rotation. As a result, the spline shaft 14 of the base portion 13 and the rotor 21 can transmit axial rotation via the rotation transmission shaft 40. Therefore, in the medicine dispensing apparatus 10, when the spline shaft 14 of the base portion 13 on which the box body 31 for an actuation portion is mounted is axially rotated under control by the controller, the rotation transmission shaft 40 and the rotor 21 are also axially rotated by the same amount as the spline shaft 14.

When the spline shaft 14 and the rotation transmission shaft 40 are axially rotated by a predetermined amount according to control by the controller, the rotor 21 of the tablet cassette 20 is rotated by the same amount in an accompanying manner, and the disk-shaped rotating body 61 of the tablet splitting apparatus 30 is rotated in synchronization therewith. As a result, one tablet that has come under the partition plate 22 along with rotation of the rotor 21 is dropped and discharged from the tablet discharging portion 23 in the tablet cassette 20, and the tablet 5 is received from the tablet receiving portion 63 and received in the recess 62 which has come directly under the tablet receiving portion 63 along with rotation of the disk-shaped rotating body 61 in the tablet splitting apparatus 30 (see FIG. 2B). Further, the tablet 5 is moved through the tablet passage 64 in an arcuate shape by movement of the recess 62 along with rotation of the disk-shaped rotating body 61, and transported to the tablet cutting position on the open/close plate 65 in the closed state.

Operation to cut the tablet is now ready. Thus, when a half tablet or cut tablet piece is needed, the motor 73 is actuated according to control by the controller to advance the advancing/retracting portions 71. When the advancing/retracting portions 71 are advanced, the movable blade unit 52 is advanced, and the open/close plate 65 is opened. Thus, the tablet at the cutting position is divided into upper and lower half tablets (cut tablet pieces), and the lower half tablet is dropped and discharged from the cut tablet piece delivering portion 66 while the upper half tablet stays on the movable blade unit 52.

When another half tablet is needed, the motor 73 is actuated, without actuating the spline shaft 14 etc., under control by the controller to retract the movable blade unit 52 together with the advancing/retracting portions 71. Thus, the remaining upper half tablet is dropped and discharged from the cut tablet piece delivering portion 66, and thereafter the open/close plate 65 is closed.

In this manner, half tablets are sequentially discharged twice. When the above operation is repeated over and over thereafter, a required number of half tablets (cut tablet pieces) are dispensed, one at a time, at appropriate timings.

When the tablet cassette 20 becomes empty after sequential discharge of half tablets, the tablet cassette 20 is detached from the tablet splitting apparatus 30 to be replenished with tablets. When the tablet cassette 20 containing tablets is mounted again to the tablet splitting apparatus 30, the medicine dispensing apparatus 10 becomes operable again.

When the tablet splitting apparatus 30 is to be cleaned, repaired, or checked for such work, further, necessary work can be performed conveniently and immediately by detaching the tablet splitting apparatus 30 from the base portion 13 after detaching the tablet cassette 20 from the tablet splitting apparatus 30 or with the tablet cassette 20 mounted to the tablet splitting apparatus 30, and thereafter mounting the tablet splitting apparatus 30 to the base portion 13 again in the reverse order.

### [Other Embodiments]

In the embodiment described above, the cable for the driver 74 is directly connected to the power source etc. for the medicine dispensing apparatus 10. However, such a cable may be indirectly connected. For example, connection with a usable wire between the power source etc. for the medicine dispensing apparatus 10 and the base portion 13, to which the box body 32 for a motor is to be mounted, can be established in advance by using an unused wire in a cable installed in advance inside the medicine dispensing apparatus 10 between the power source etc. and the base portion 13 or adding a wire by adding a cable or replacing the cable. Further, the motor 73 can be made operable in an accompanying manner when the tablet splitting apparatus 30 is mounted to adjacent base portions 13 and 13 by disposing terminals of usable wires at the upper end portion of the base portion 13 and disposing terminals of wires for the driver 74 at the lower end portion of the box body 32 for a motor.

### DESCRIPTION OF REFERENCE NUMERALS

5 tablet
10 medicine dispensing apparatus
11 tablet feeder storage
12 shelf
13 base portion (tablet feeder)
14 spline shaft (driving shaft)
15 cut tablet piece receiving portion
16 standard tablet cassette (tablet feeder)
20 tablet cassette
21 rotor
22 partition plate
23 tablet discharging portion
30 tablet splitting apparatus
31 box body for actuation portion
32 box body for motor
40 rotation transmission shaft
41 upper end portion
42 meshing blade
43 lower end portion
44 meshing wall
50 cutting mechanism
51 fixed blade unit
52 movable blade unit
60 tablet guiding mechanism
61 disk-shaped rotating body
62 recess
63 tablet receiving portion
64 tablet passage
65 open/close plate
66 cut tablet piece delivering portion
70 driving mechanism
71 advancing/retracting portion
72 rotation/reciprocation conversion portion
73 motor
74 driver

1. A tablet splitting apparatus comprising:
a tablet guiding mechanism configured to receive a fallen tablet and guide the tablet to a cutting position;
a cutting mechanism capable of cutting the tablet at the cutting position;
a driving mechanism provided at a side of the cutting mechanism to drive the cutting mechanism; and
a box body that houses the tablet guiding mechanism and the cutting mechanism,
the tablet splitting apparatus being housed in a tablet dispensing apparatus including a plurality of tablet cassettes and configured to cut the tablet falling from corresponding one out of the plurality of tablet cassettes, the tablet cassettes each containing a plurality of tablets in a random manner and each configured to discharge the plurality of tablets, one at a time, to allow the table to fall from a tablet discharging portion of the tablet cassette as a rotor rotates to align the plurality of tablets, wherein:
the box body includes a rotation transmission shaft that extends vertically and a rotation transmission mechanism that causes a movable portion of the tablet guiding mechanism to operate as the rotation transmission shaft rotates;
the box body has a lower portion placed on a base portion of a tablet feeder for the tablet cassette, and an upper portion on which the tablet cassette is placed;
the upper portion of the box body has a through hole formed therein, from which an upper end portion of the rotation transmission shaft is exposed, and includes a tablet receiving portion that receives the tablet discharged from the tablet discharging portion;
a lower end portion of the rotation transmission shaft is exposed from the lower portion of the box body, and the lower portion of the box body includes a cut tablet piece delivering portion configured to deliver a plurality of cut tablet pieces formed by cutting the tablet using the cutting mechanism;
the lower end portion of the rotation transmission shaft is coupled to a driving shaft of the base portion so as to be able to transmit rotation, and the cut tablet piece delivering portion of the tablet guiding mechanism is coupled to a tablet receiving portion of the base portion, by placing the box body on the base portion of the tablet feeder; and
the upper end portion of the rotation transmission shaft is coupled to the rotor in the tablet cassette so as to be able to transmit rotation, and the tablet receiving portion of the tablet guiding mechanism is coupled to the tablet discharging portion of the tablet cassette, by placing the tablet cassette on the box body.

2. The tablet splitting apparatus according to claim 1, wherein:
the tablet guiding mechanism includes, as the movable portion a disk-shaped rotating body, in a peripheral portion of which a plurality of recesses are formed; and
the disk-shaped rotating body is coupled to the rotation transmission shaft via the rotation transmission mechanism so as to be able to transmit rotation, and is rotated to move the tablets which are received and held in the recesses.

3. The tablet splitting apparatus according to claim 2, wherein:
a virtual center line that passes through a center of rotation of the disk-shaped rotating body extends in a direction orthogonal to an axis of the rotation transmission shaft; and
the rotation transmission mechanism which is located between the rotation transmission shaft and the disk-shaped rotating body is a bevel gear mechanism.

4. The tablet splitting apparatus according to claim 2, wherein
a ratio of rotation transmission from the rotation transmission shaft to the rotor of the tablet cassette and a ratio of rotation transmission from the rotation transmission shaft to the disk-shaped rotating body are correlated to synchronize tablet discharge from the tablet cassette and tablet reception into the recesses of the disk-shaped rotating body.

5. The tablet splitting apparatus according to claim 4, wherein
the tablet guiding mechanism includes:
a rotating body housing portion configured to rotatably receive the disk-shaped rotating body and prevent the tablet which is received in the recess from getting out of the recess until the tablet comes to the cutting position; and
an open/close plate disposed under the disk-shaped rotating body to be brought into a closed state to prevent the tablet from falling from the recess when the tablet comes to the cutting position, and brought into an open state to enable the plurality of cut tablet pieces to fall into the cut tablet piece delivering portion when the tablet is cut.

6. The tablet splitting apparatus according to claim 1, wherein:
the cutting mechanism includes a movable blade driven by the driving mechanism and a fixed blade provided to face the movable blade, wherein the tablet which is held in the recess of the disk-shaped rotating body and located at the cutting position, is interposed between the movable and fixed blades;
the driving mechanism includes a driving rotary shaft having an axis line extending in parallel with a virtual line extending in a direction orthogonal to an axial direction of the rotation transmission shaft and located opposite to the fixed blade with the rotation transmission shaft interposed therebetween, a cam fixed to the driving rotary shaft, and a follower moved by the cam; and
the cam and the follower are configured to move the movable blade, which is located opposite to the driving rotary shaft with the rotation transmission shaft interposed therebetween, so as to approach and depart from the fixed blade.

7. The tablet splitting apparatus according to claim 6, wherein
the open/close plate is configured to be driven by the driving mechanism in synchronization with movement of the movable blade.

8. The tablet splitting apparatus according to claim 1, wherein
respective heights of the box body and the tablet cassette are determined such that a height of an assembly constituted by placing the tablet cassette on the box body is equal to or less than a height of a standard tablet cassette placed on the base portion.

9. A tablet dispensing apparatus comprising the tablet splitting apparatus according to claim 1.

10. The tablet splitting apparatus according to claim 3, wherein
a ratio of rotation transmission from the rotation transmission shaft to the rotor of the tablet cassette and a ratio of rotation transmission from the rotation transmission shaft to the disk-shaped rotating body are correlated to synchronize tablet discharge from the tablet cassette and tablet reception into the recesses of the disk-shaped rotating body.

11. The tablet splitting apparatus according to claim 10, wherein
the tablet guiding mechanism includes:
a rotating body housing portion configured to rotatably receive the disk-shaped rotating body and prevent the tablet which is received in the recess from getting out of the recess until the tablet comes to the cutting position; and
an open/close plate disposed under the disk-shaped rotating body to be brought into a closed state to prevent the tablet from falling from the recess when the tablet comes to the cutting position, and brought into an open state to enable the plurality of cut tablet pieces to fall into the cut tablet piece delivering portion when the tablet is cut.

12. The tablet splitting apparatus according to claim 2, wherein:
the cutting mechanism includes a movable blade driven by the driving mechanism and a fixed blade provided to face the movable blade, wherein the tablet, which is held in the recess of the disk-shaped rotating body and located at the cutting position, is interposed between the movable and fixed blades;
the driving mechanism includes a driving rotary shaft having an axis line extending in parallel with a virtual line extending in a direction orthogonal to an axial direction of the rotation transmission shaft and located opposite to the fixed blade with the rotation transmission shaft interposed therebetween, a cam fixed to the driving rotary shaft, and a follower moved by the cam; and
the cam and the follower are configured to move the movable blade, which is located opposite to the driving rotary shaft with the rotation transmission shaft interposed therebetween, so as to approach and depart from the fixed blade.

13. The tablet splitting apparatus according to claim 12, wherein
the open/close plate is configured to be driven by the driving mechanism in synchronization with movement of the movable blade.

14. The tablet splitting apparatus according to claim 3, wherein:
the cutting mechanism includes a movable blade driven by the driving mechanism and a fixed blade provided to face the movable blade, wherein the tablet, which is held in the recess of the disk-shaped rotating body and located at the cutting position, is interposed between the movable and fixed blades;
the driving mechanism includes a driving rotary shaft having an axis line extending in parallel with a virtual line extending in a direction orthogonal to an axial direction of the rotation transmission shaft and located opposite to the fixed blade with the rotation transmission shaft interposed therebetween, a cam fixed to the driving rotary shaft, and a follower moved by the cam; and
the cam and the follower are configured to move the movable blade, which is located opposite to the driving rotary shaft with the rotation transmission shaft interposed therebetween, so as to approach and depart from the fixed blade.

15. The tablet splitting apparatus according to claim 14, wherein
the open/close plate is configured to be driven by the driving mechanism in synchronization with movement of the movable blade.

16. The tablet splitting apparatus according to claim 4, wherein;
the cutting mechanism includes a movable blade driven by the driving mechanism and a fixed blade provided to face the movable blade, wherein the tablet, which is held in the recess of the disk-shaped rotating body and located at the cutting position, is interposed between the movable and fixed blades;
the driving mechanism includes a driving rotary shaft having an axis line extending in parallel with a virtual line extending in a direction orthogonal to an axial direction of the rotation transmission shaft and located opposite to the fixed blade with the rotation transmission shaft interposed therebetween, a cam fixed to the driving rotary shaft, and a follower moved by the cam; and
the cam and the follower are configured to move the movable blade, which is located opposite to the driving rotary shaft with the rotation transmission shaft interposed therebetween, so as to approach and depart from the fixed blade.

17. The tablet splitting apparatus according to claim 16, wherein
the open/close plate is configured to be driven by the driving mechanism in synchronization with movement of the movable blade.
